(19) United States
(12) Patent Application Publication
(10) Pub. No.: US 2007/0225426 A1
(43) Pub. Date: Sep. 27, 2007

(54) Nylon 11/Filler/Modifier Composites

(75) Inventors: Xueping Li, Austin, TX (US); Dongsheng Mao, Austin, TX (US); Zvi Yaniv, Austin, TX (US)

Correspondence Address: FISH & RICHARDSON P.C., P.O BOX 1022, Minneapolis, MN, 55440-1022, US

(73) Assignee: NANO-PROPRIETARY, INC., Austin, TX (US)

(21) Appl. No.: 11/690,713

(22) Filed: Mar. 23, 2007

Related U.S. Application Data
(60) Provisional application No. 60/785,696, filed on Mar. 24, 2006.
(60) Provisional application No. 60/819,443, filed on Jul. 7, 2006.

(51) Int. Cl. C08F 290/04

(52) U.S. Cl. 524/504

(57) ABSTRACT

A nylon 11 composite system has significantly improved flexural modulus while keeping or even increasing the impact strength. This composite system may comprise a nylon 11/filter/modifier. The flexural modulus and impact strength increases over 150% and 80%, respectively compared with neat nylon 11. The “ball” portion of badminton shuttlecocks made by this type of composite may more closely duplicate the flight capabilities of natural duck feather shuttlecocks than nylon 11. The nylon 11/filler/modifier ay allow for a very close duplication of the restoration effects of shuttlecocks made from feathers therefore providing a product which can be a one for one aerodynamic performance substitution for the natural product (feathers).

This application claims priority to U.S. Provisional Patent Application Ser. Nos. 60/785,696, and 60/819,443 which are incorporated by reference herein.

### BACKGROUND INFORMATION

Nylon 11 is an important commercial polymer with excellent piezoelectricity and mechanical properties and used in a large range of industrial fields from automotive to offshore applications (Tianxi Liu, Kian Ping Lim, Wuiwui Chauhare Tjiu, K. P. Pramoda, Zhi-Kuan Chan, “Preparation and characterization of nylon 11/organoclay nanocomposites”, Polymer 44, 3529-3535(2003)). Nylon 11 is an acceptable material to be used as a shuttlecock (a high-drag projectile with an open conical shape and a rounded head) in the game of badminton because of its excellent overall properties such as impact strength, low melt index, and water resistance properties (Qin Zhang, Min Yu and Qiang Fu, “Crystal morphology and crystallization kinetics of polyamide-11/clay nanocomposites”, Polymer International 53, 1941-1949(2004)). In comparison to shuttlecocks made out of feathers of goose or duck, those made out of synthetic nylon 11 are cheaper and more durable. However, the performance of shuttlecocks made out of synthetic nylon 11 is not as good as the performance of shuttlecocks made out of feathers based on the “feeling” of the shuttlecocks for the players of the game of badminton.

In particular, a shuttlecock made out of nylon 11 may feel too soft. Its flexural modulus is around 400-500 MPa (millipascal) which is much lower than that of a feather shuttlecock. As a result, the existing nylon 11 material does not allow the shuttlecock to restore its shape quickly enough. This causes prolonged wobbling and a decrease in flight distance as compared to the natural product (using feathers). On the other hand, feather shuttlecocks, due to their rigidity, restore almost instantaneously to the aerodynamic shape of the shuttlecock thereby permitting a nearly flawless flight with little, if any, wobble induced in the flight path.

Fillers, such as clay, have previously been used to reinforce nylon 11 composites (T. D. Fornes and D. R. Paul, “Structure and properties of nanocomposites based on nylon 11 and 12 compared with those based on nylon 6”, Macromolecules 37, 7698-7709(2004)). The flexural modulus increased about 80% with a 5.7 wt. % loading of the clay. However, the impact strength decreased 70%, which would significantly lower the performance of the shuttlecock.

### BRIEF DESCRIPTION OF THE DRAWINGS

FIG. 1 illustrates a flow diagram; and

FIG. 2 illustrates a shuttlecock configured in accordance with embodiments of the present invention.

### DETAILED DESCRIPTION

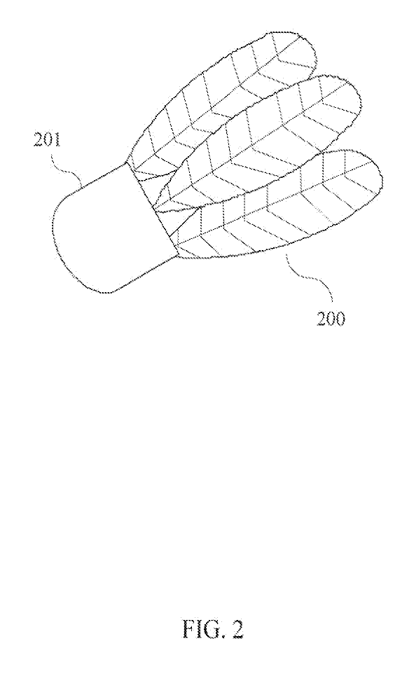

A nylon 11 composite system in accordance with embodiments of the present invention has significantly improved flexural modulus while keeping or even increasing the impact strength. This composite system may comprise a nylon 11/filler/modifier. An example of such a composite system is nylon 11 (45% wt.)/clay (20% wt.)/elastomer (35% wt.). The flexural modulus and impact strength increases over 150% and 80%, respectively compared with neat nylon 11. The “ball” portion 201 of Badminton 200 shuttlecocks (FIG. 2) made by this type of composite may more closely duplicate the flight capabilities of natural duck feather shuttlecocks than nylon 11. The nylon 11/filler/modifier may allow for a very close duplication of the restoration effects of shuttlecocks made from feathers therefore providing a product which can be a one for one aerodynamic performance substitution for the natural product (feathers). Further, the nylon 11/filler/modifier will not only perform equally the same as the natural product but will be easier and cheaper to manufacture and more durable than the natural product.

In this nylon 11 composite system, besides clay, other fillers, such as graphite particles, carbon black, carbon fibers, fullerenes, carbon nanotubes, glass fibers, ceramic particles, or any other metallic semiconductive, or insulating particles may also work. Beside elastomer, other polymer modifiers such as plasticizer, compatiblizer, or other impact modifiers may also work including a maleic anhydride grafted modifier, such as a maleic anhydride grafted polyolefin elastomer, such as ethylene-propylene, polyethlene-octene. The modifier may have at lease two functions in the composite:

1. The elastomer may better disperse clay particles which may be important to improve mechanical properties of the polymer/clay nanocomposites such as flexural modulus;

2. The elastomer may give the polymer rubbery properties which may improve the impact strength.

In one embodiment of the present invention, nylon 11 pellets were mixed with clay and elastomer powders by a ball milling process followed by an extrusion (melt compounding) process. A detailed example of this embodiment is provided in an effort to better illustrate the present invention.

Nylon 11 pellets are obtained from Arkema Co., Japan (product name: RILSAN BMV-P20 PA11). Clay is provided by Southern Clay Products, U.S. (product name: Cloisite® series 93A). It is a natural montmorillonite modified with a ternary ammonium salt. The elastomer is styrene/ethylene butylenes/styrene (SEBS), purchased from Kraton Inc., U.S. (product name: G1657).

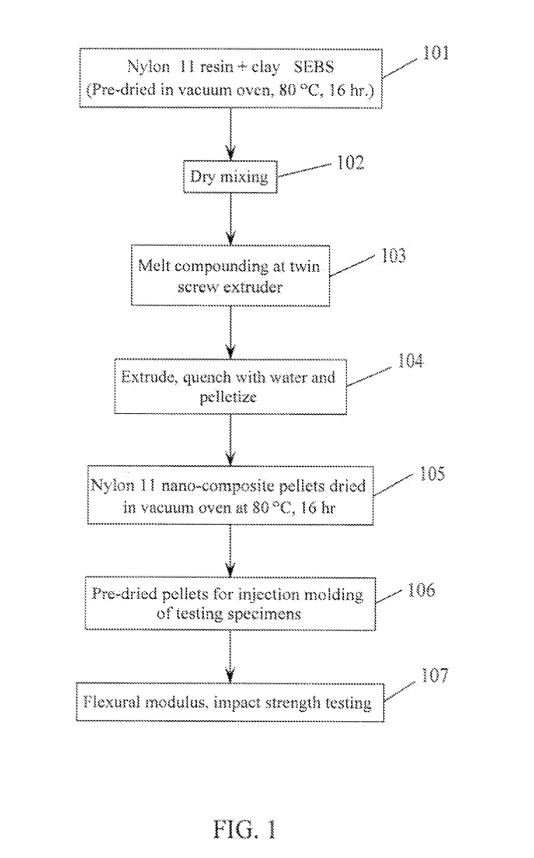

FIG. 1 shows a shcematic diagram of a process flow to make nylon 11/clay/SEBS composites. In step 101, all three ingredients are dried in a vacuum oven at 70° C. for at least 16 hours to fully eliminate moisture. In step 102, they are placed in a plastic bag at different weight ratios and mixed by hand for at least a half an hour in order to obtain uniform dispersion of the materials. In step 103, a HAAKE Rheomex CTW 100 twin screw extruder (Germany) is used to blend nylon6/clay/SEBS nanocomposites. Following are the parameters used in this process:

Screw zone 1 temperature—230° C.;

Screw zone 1 temperature—220° C.;

Screw zone 1 temperature—220° C.;

Die temperature—230° C.;

Screw speed—100 rpm.

A minimum quantity of the nylon 11 pellets and clay for each operation may be 1 pound because the twin screw needs to be cleaned using the mixture before collecting the composite resin. In step 104, the nanocomposite fiber is quenched in water and palletized using a Haake PP1 Palletizer POSTEX after an extrusion process. In step 105, the nanocomposite pellets are dried at 70° C. prior to the injection molding process. In step 106, a Mini-Jector (Model 55, Mini-Jector Machinery Corp. Newbury, Ohio , USA) laboratory-scale injection molding machine is used to make impact bars. The samples may be molded for testing with specific dimensions using ASTM-specified molds (ASTM D256 for impact strength testing. ASTM D790 for flexural modulus testing). Following are the parameters used:

Injection pressure—70 bar;

Holding pressure—35 bar;

Holding time—40 seconds;

Heating zone 1 temperature—220° C.;

Heating zone 2 temperature—220° C.;

Nozzle temperature—230° C.;

Mold temperature—60-80° C.

The specimens may be dried in a desiccator for at least 40 hours' conditioning before a testing process. Flexural modulus and impact of the samples may be characterized using a standard 3-point bending method in step 107.

Table 1 shows the mechanical properties (flexural modulus and impact strength) of nylon 11/clay/SEBS composites with different weight ratios:

TABLE 1

| | | | | | | Impact |
|---|---|---|---|---|---|---|
| | Nylon | | Rubber | Extrusion | Flexural | strength |
| Sample | 11 | Clay | SEBS | speed | modulus | (kgf cm/ |
| ID | Wt. % | Wt. % | Wt. % | (rpm) | (GPa) | cm) |
| 1 | 100 | 0 | 0 | NA | 0.572 | 38.5 |
| 2 | 95 | 5 | 0 | 100 | 0.928 | 21.2 |
| 3 | 90 | 10 | 0 | 100 | 1.33 | 20.4 |
| 4 | 80 | 20 | 0 | 100 | 1.90 | 12.5 |
| 5 | 76 | 20 | 4 | 100 | 2.11 | 11.0 |
| 6 | 72 | 20 | 8 | 100 | 2.09 | 20.1 |
| 7 | 70 | 15 | 15 | 100 | 1.74 | 30.7 |
| 8 | 60 | 20 | 20 | 100 | 2.01 | 28.0 |
| 9 | 45 | 20 | 35 | 100 | 1.60 | 72 |

A total number of 9 composites were made and tested, as can be seen in Table 1. Compared with neat nylon 11 (sample 1), by increasing the clay loading (samples 2, 3, 4,), the flexural modulus of the samples was increased. However, the impact strength was decreased. Samples 5-9 are the nylon 11/clay/SEBS composites. In general, the flexural modulus of the composites should be decreased by adding modifiers. Compared with sample 4, the flexural modulus of samples 5 and 6 was increased by adding 4 and 8 wt. % SEBS loading. The flexural modulus may have increased because the clay particles were better dispersed by adding low viscosity SEBS during the extrusion process which may be important to improve the flexural modulus of the composites. With respect to samples 5-9, the impact strength was increased by increasing the SEBS loading. Sample 9, which has 35 wt. % SEBS loading, has a much higher impact strength than that of neat nylon 11 (increased by 77.8%). Further, sample 9 has its flexural modulus increased by about 178% in comparison with neat nylon 11.

1. A composite comprising nylon 11, a filler, and a maleic anhydride grafted modifier.

2. The composite as recited in claim 1, wherein an content of the nylon 11 is 20-98 wt. %, a content of filler is 1-50 wt. %, and a content of the modifier is 1-60 wt. %.

3. The composite as recited in claim 1, wherein the filler comprises one or more of the following: organic clay, inorganic clay, graphite, carbon black, C60, carbon nanotubes, carbon fiber, ceramic, glass fiber, or any other metallic, semiconductive, and insulating particles.

4. A badminton shuttlecock comprising a composite material of nylon 11, a filler, and a maleic anhydride grafted modifier.

5. The badminton shuttlecock as recited in claim 4, wherein the filler comprises one or more of the following: organic clay, inorganic clay, graphite, carbon black, C60, carbon nanotubes, carbon fiber, ceramic, glass fiber, or any other metallic, semiconductive, and insulating particles.
